(19) United States
(12) Patent Application Publication
(10) Pub. No.: US 2018/0287112 A1
(43) Pub. Date: Oct. 4, 2018

(54) ELECTRICAL ENERGY STORAGE MODULE AND METHOD FOR PRODUCING SAME

(71) Applicant: BLUE SOLUTIONS, Ergue Gaberic (FR)

(72) Inventors: Anne-Claire JUVENTIN, Saint Nazaire (FR); Olivier CAUMONT, Quimper (FR)

(21) Appl. No.: 15/765,996

(22) PCT Filed: Oct. 5, 2016
(86) PCT No.: PCT/EP2016/073762

§ 371 Date: Apr. 4, 2018

(30) Foreign Application Priority Data
Oct. 5, 2015 (FR) 1559425

(51) Int. Cl. H01M 2/10; H01M 10/42; H01M 10/613; H01M 10/6551; H01G 11/82; H01G 11/84; H01G 11/18

(52) U.S. Cl. CPC H01M 2/1016; H01M 2/1094; H01M 10/4257; H01G 11/18; H01M 10/6551; H01G 11/82; H01G 11/84; H01M 10/613

(57) ABSTRACT

The invention concerns an electrical energy storage module (1) containing electrical energy storage elements (3), and a method for producing the same. This module is remarkable in that it comprises: —a parallelepiped easing (2) made of sheet metal, inside which said electrical energy storage elements (3) are housed, —at least one electronic board (4), arranged in a facade element (50), which is itself attached to one of the faces of said parallelepiped casing (2), and in that said electrical energy storage elements (3) are held in place and immobilised in the casing (2) by two layers of resin extending only over a portion of the height of same and arranged at the two ends of the electrical energy storage elements (3).

### GENERAL TECHNICAL FIELD

The invention is situated in the general technical field of production of an electrical energy storage module. Such a module comprises an parallelepiped outer casing which contains a plurality of electrical energy storage assemblies.

The present invention relates more precisely to such a module, designed for all types of applications, both stationary (for example the use of a module in a building or a shelter, etc . . . ) and movable (for example the use of the module in a land vehicle, such as a tram, a bus or a car). For this reason, such a module must be capable of being positioned in numerous orientations, particular to be able to adapt to different arrangements and to different dimensions associated with different applications.

The invention also relates to a method for producing such a module.

A “module” is an assembly comprising a plurality of energy storage elements, disposed side by side and connected electrically, generally in series. It makes it possible to supply in a single block assemblies of energy storage elements tolerating a higher voltage and supplying a greater storage capacity than unit elements.

Moreover, hereafter in the description and the claims, what is meant by “electrical energy storage assembly” is either a capacitor (i.e. a passive system comprising two electrodes and an insulator), or a supercapacitor (i.e. a system comprising at least two electrodes, an electrolyte and at least one separator), particularly of the hybrid type (i.e. comprising an electrode of the type known as “EDLC” or electric double-layer capacitor, i.e. a capacitor with an electrochemical double layer—and an electrode of the lithium battery type), or a battery of the lithium battery type (that is a system comprising at least one anode, at least one cathode and a liquid or solid electrolyte between the anode and the cathode).

### PRIOR ART

Known from document US2014/0242436, is such an electrical energy storage module, which comprises a parallelepiped outer casing containing electrical energy storage assemblies. The outer casing consists of a sleeve made by extrusion and cut depending on the length of the module that it is desired to produce, this sleeve being blocked at each of its two ends by a plate. The wall of this sleeve is shaped so as to have, in cross section, a form with several lobes shaped as portions of circular arcs, each lobe assuming a portion of the contour of the cylindrical energy storage elements.

Such a module, however, allows storing a maximum of two superimposed rows of energy storage elements, so that each of these elements can be in contact with the wall of the sleeve.

Moreover, the energy storage elements positioned in the middle (for example in the middle of a row of three elements set side by side or in the middle of an alignment of three elements mounted one behind the other, as can be seen in FIG. 2 of this document) are poorly retained by the sleeve. Such a module can therefore not be positioned on the edge without risking damage to the energy storage elements. In fact, these risk sagging one on top of the others, which could cause short-circuits.

In addition, the sleeve also plays the role of thermal conductor for removing heat. The cooling of the energy storage elements positioned in the middle is therefore mediocre because their contact surface area with the sleeve is small.

According to a variant embodiment of this module, it is possible to add a filler material to it, capable of transmitting heat to the outside, this material filling some or all of the existing spaces between the outer casing and the energy storage elements.

This document, however, absolutely does not describe a module conforming to the invention, in which the energy storage elements are held in place by two layers of resin placed only at their respective ends.

Also known from document EP2639853 is a module containing batteries. This module comprises a case made of an insulating material of which the bottom and the cover have partition plates with a small height, which delimit reception spaces for the ends of the batteries.

The inner surface of these spaces is coated with a foam layer. As can be seen in the figures of this document, the foam layer has a greater height on the walls of the module than on the partitions, which means that the foam layer is formed before the batteries are set in place and not after the closure of the module.

The batteries are inserted in the spaces of the case from above, by pressing on the foam layer, then the cover is applied to the assembly. The batteries are thus held in place.

However, this device does not allow easy adaptations to variations of manufacturing tolerance in the batteries, so that in certain cases, the battery may not enter the space provided for that purpose or, conversely, it may be insufficiently retained.

Moreover, the document absolutely does not consider the problem area of removal of the heat produced by the batteries.

Also known from document EP2403050 is a device comprising a trunk containing a plurality of lithium electrochemical generators. An electrically insulating, rigid flame-retardant foam fills the space between the inner wall of the trunk and the outer surface of the generators.

The flame-retardant foam achieves excellent thermal insulation, which is contrary to the goal sought by the invention. The use of a resin is discouraged by this document.

Also known from document WO 2012/078727 is an energy storage module the elements of which are self-supported and simply inserted between two rails and two end plates.

Such a structure allows only “flat” positioning, that is on the bottom, but not on any side of the module.

There also exist modules whose casing is made of plastic material. In this type of module, the plastic casing serves in particular as a protection element against climatic adverse weather but does not allow cooling of the cells. In addition, the casing alone does not allow protection against electromagnetic currents. Finally, the necessary tooling for molding of this type of casing is expensive.

Finally, a module is known like that shown in the appended FIG. 1, produced by the applicant. Such a module M comprises a casing consisting of ten extruded profile parts, assembled by means of at least sixty or so screws, so as to become a lower wall PI, an upper wall PS, a front wall AV, a rear wall AR, two longitudinal side walls PL as well as inner partitions. The module comprises two output terminals BS, situated on the front wall AV, which allow its connection to the device to be supplied with energy.

For certain applications, this module M is considered too heavy, too expensive and difficult to mass produce due to the large quantity of parts and screws to be assembled.

In addition, the dimensions of the extruded profiles used are limited by the capacity of extrusion presses. For large-sized modules, this involves the multiplication of the number of extruded parts.

Moreover, the inner chocking of the electrical energy storage modules is accomplished only by means of flexible parts, of the rubber ring type.

This module, currently equipped with energy storage elements of the super-capacitor type, operates very well. However, it is not designed to be placed in any other than the position called “flat,” i.e. that in which the module M rests on its lower wall Pl.

Other use positions of this module M, such as for example with the output terminals BS directed upward (i.e. with the module positioned on its rear wall AR) or positioning on the edge (i.e. with the module placed on one of the side walls PL), risk causing sagging of the energy storage elements inside the module.

This can cause a loss of sealing at the output terminals BS, as well as short-circuits due to damage to the inner electrical insulation systems under the influence of new mechanical constraints linked to the position of use of the module.

### PRESENTATION OF THE INVENTION

The invention has as its objective to resolve the aforementioned disadvantages of the prior art.

The invention therefore has as its objective to provide an electrical energy storage module comprising a parallelepiped casing, inside which are stored several electrical energy storage elements, this module being able to be positioned on four of its six faces, i.e. its lower wall PI, its rear wall AR and its two side walls PL, or possibly on its front wall AV, even though in this case access to the output terminals BS is more difficult.

This objective must be attained while still providing a mechanically resistant module which is less heavy, less costly and less complex to produce than the known modules of the prior art.

In addition, this improvement of the mechanical strength and this possibility of use in multiple positions must not be accomplished to the detriment of the electrical insulation quality of the module. Such a module must be able to continue to be used even with high voltages, while still being protected against electromagnetic fields.

Finally, advantageously, another objective of the invention is also to provide a module as aforementioned, in which the cooling of the electrical energy storage elements is correctly provided for.

To this end, the invention relates to an electrical energy storage module containing electrical energy storage elements.

In conformity with the invention, this module comprises:
a parallelepiped casing made of sheet metal, inside of which are housed said electrical energy storage elements, said casing comprising a bottom assembled to a hood with five faces,
at least one electronic card, disposed in a facade element, itself attached to one of the faces of said parallelepiped casing,

and said electrical energy storage elements are held in place and immobilized in the casing by a first resin layer which extends from said bottom over only a portion of the height of said electrical energy storage elements, and by a second resin layer which extends from one of the faces of the hood over only a portion of the height of said electrical energy storage elements.

Thanks to these features of the invention, the module can be positioned on its lower wall, its rear wall, its front wall or its side walls. The energy storage elements are held by the resin and do not risk sagging on top of one another.

The use of preferably thin sheet metal makes it possible to lighten the total weight of the module. This sheet metal, however, combined with the resin, is sufficient to hold correctly the energy storage elements.

The resin, combined with the use of a casing made of metal (a good thermal conductor), facilitates the removal of heat from the electrical energy storage elements to the exterior.

The resin also reinforces the sealing of the module.

The fact of having an electronic card disposed in a facade element outside the casing further allows not having to have access to the interior of it and not degrading the chocking of the energy storage elements in this casing.

Thanks to all the features of the invention, the module is optimized in terms of mass, cost and sealing.

According to other advantageous and non-limiting features of the invention, taken alone or in combination:
the module comprises two openings provided in the casing for the injection of resin into the casing, and preferably closing plugs for the two openings;
the two openings are formed on the front face of the hood, one situated in proximity to the bottom and the other situated in proximity to the upper face of the hood;
the two openings are formed, one in the bottom, the other in the upper face of the hood;
said casing is liquid-tight and dust-tight;
the casing is made of sheet metal of which the thickness is at most 5 mm;
the module comprises a core, preferably central, forming a spacer, disposed between the bottom and the hood perpendicular to them;
the resin extends over 5% to 20%, preferably 5% to 12%, of the height of the electrical energy storage elements;
the wall of its casing includes a crenelated surface;
the casing includes, over at least one of its faces, several heat-dissipating elements, such as cooling fins, preferably welded to this face;
the facade element comprises a rear portion and a front portion equipped with assembly means allowing to assemble them to form an enclosure for receiving said electronic card, said rear portion being made of an electrically insulating material and being provided with attachment means on one of the faces of the casing and the front portion being made of an electrically conductive material, particularly a metal;
the facade element is pierced with ports allowing the passage of the output terminals, with positive and negative polarity, of said module.

The invention also relates to a method for producing this electrical energy storage module, which comprises the steps of:
assembling the electrical energy storage elements in pairs using connecting bars,
implementing the electrical cabling and installing the insulators so as to form an isolated power block,
placing said power block inside the casing,
assembling the bottom and the hood of said casing,
injecting resin through a first opening of the casing to form said first resin layer,
waiting for the polymerization of the resin,
turning the module over,
injecting resin through a second opening of the casing to form a second resin layer,
attaching the facade element containing the electronic card to the casing.

### PRESENTATION OF THE FIGURES

Other features and advantages of the invention will appear from the description which will now be made, with reference to the appended drawings, which show, by way of indication but without limitation, a possible embodiment.

In these drawings:

FIG. 1 is a perspective schematic showing an electrical energy storage module conforming to the prior art,

FIG. 2 is an exploded perspective view, showing an exemplary embodiment of the electrical energy storage module conforming to the invention,

FIG. 3 is a perspective view showing the module of FIG. 2 in the assembled position,

FIG. 4 is a schematic view, in section, of a portion of the module conforming to the invention,

FIG. 5 is a top view, in perspective, from the interior of the casing of the module conforming to the invention,

FIG. 6 is an exploded detail view, in perspective, of a facade element allowing the storage of the electronic card of the module conforming to the invention,

FIG. 7 is a detail view of the same module showing the mounting of an output terminal,

FIG. 8 is a detail section view of a portion of the storage module conforming to the invention, and

FIG. 9 is a partial section view of the storage module conforming to the invention.

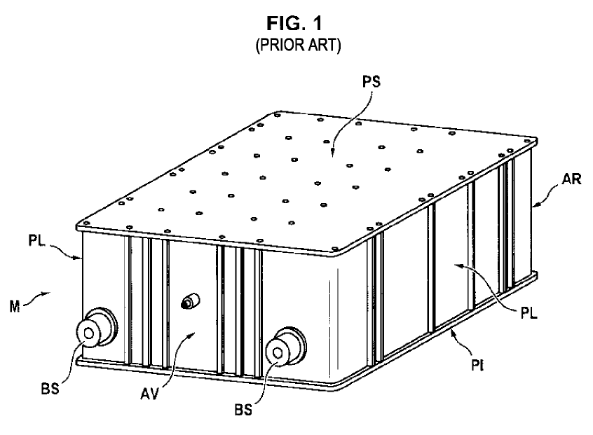

### DETAILED DESCRIPTION OF THE INVENTION

One example of an embodiment of the module conforming to the invention will now be described with reference to the figures.

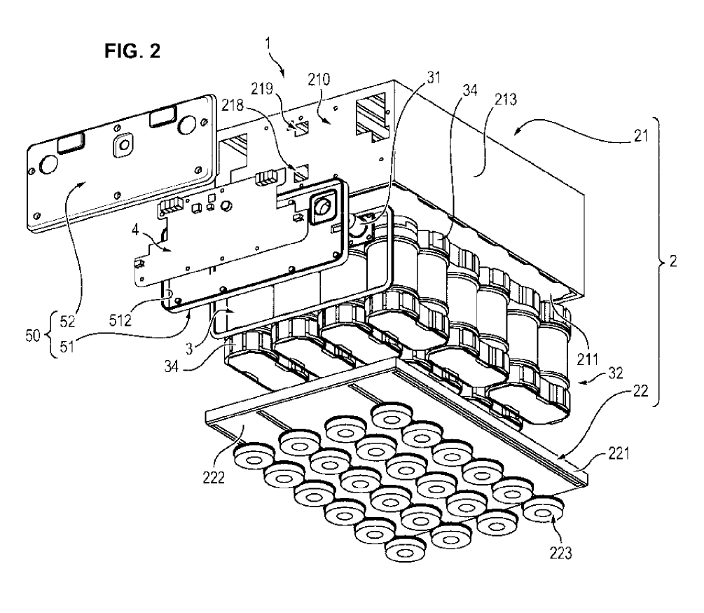

In FIG. 2, it can be seen that the module 1 comprises a parallelepiped casing 2, inside which are housed several electrical energy storage elements 3.

In addition, at least one electronic card 4, preferably only one, disposed inside a facade element 50, allows in particular the management of the operation of said storage elements 3, and therefore of the module 1.

The different elements constituting the module will now be described in greater detail.

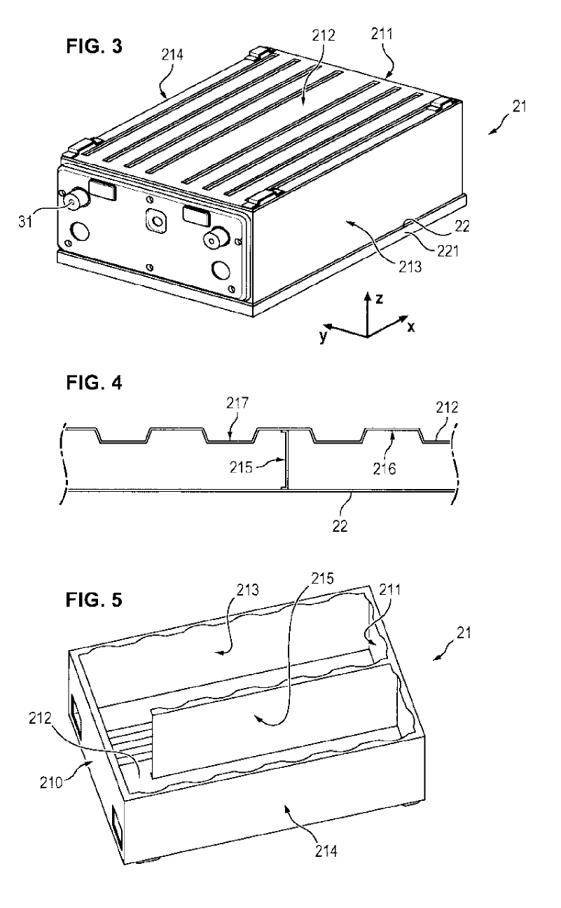

The casing 2 comprises a hood 21 with five faces, and a bottom 22, intended to be assembled to one another, as shown in FIG. 3, so as to delimit an enclosure inside which are housed the electrical energy storage elements 3.

The hood 21 and the bottom 22 are preferably made of an electrically conductive material, and preferably of thin sheet metal, aluminum or steel for example. Its thickness is preferably less than 5 millimeters, more preferably comprised between 0.5 and 5 mm. The sheet metal preferably has constant thickness. However, sheet metal with zones of variable thickness is usable.

As can be seen in FIGS. 2, 3 and 5, the hood 21 has five faces, namely a front face 210, an opposite rear face 211, an upper face 212 and two longitudinal side faces 213, 214.

Advantageously, this hood 21 is obtained by cutting out a planar piece of sheet metal so as to delimit the four faces perpendicular to the upper face 212, then bending and welding the different faces along their respective edges. Depending on the dimensions of the hood 21, stamping is also practicable.

Advantageously, the sheet metal can be shaped, preferably prior to bending, by stamping for example, so as to have a crenelated surface, as is better shown in FIG. 4. In other words, the sheet metal is deformed so as to alternately show protruding rectilinear portions 216 and sunken rectilinear portions or recesses 217.

Such a structure allows the mechanical reinforcement of the thin sheet metal and therefore of the module, without increasing the weight thereof.

Advantageously, a core 215, preferably central, connects the bottom 22 to the upper face 212 of the hood 21, as is better shown in FIGS. 4 and 5. This central core 215 extends over at least a portion of the length, or the width of the hood 21. It preferably has a C shaped cross-section, the branches of the C being secured, preferably by welding, to the hood 21 and to the upper face 212.

This central core 215 serves as a reinforcement and stiffener of the module. Its disposition inside the hood 21 and the positioning of its anchorage points are selected so as to optimize the desired mechanical retention, particularly with respect to vibratory forces, shocks, electrical forces causing inflation of the elements 3, etc.

Such a hood 21 replaces by itself nine parts of a module of the prior art. It also allows an optimal gain in mass.

The bottom 22 is advantageously implemented based on thin sheet metal, of square or rectangular shape, the edges 221 of which are folded. This makes it possible to have a bottom that caps the side 213, 214, front 210 and rear 211 faces of the hood 21.

Advantageously, the hood 21 and the bottom 22 are assembled for example using clipping or using a few screws.

The bottom 22 preferably has a planar exterior face 222, on which are preferably disposed heat dissipation elements 223, such as cooling fins (see FIG. 2).

Advantageously, these cooling fins 223 have a circular contour and are disposed vertically in relation to the energy storage elements 3 which themselves are disposed inside the casing 2. These cooling fins are for example welded to the bottom 22. This allows a reduction in the cost of the module with respect to those of the prior art in which the cooling fins are obtained by machining from the solid part.

The fins 223 can also be welded by resistance welding, by stir-friction welding, riveted by a self-punching riveter or brazed, for example. The fins 223 can also be glued using a thermally conductive adhesive, this action being completed, or not, by one of the aforementioned mechanical connections.

It will be noted that heat-dissipating elements could also be provided on the faces of the hood 21.

In FIG. 2, the energy storage elements 3 are successively interconnected two by two by a connecting bar 30, (visible only in FIG. 8), generally for series connection, and the two energy storage elements 3 located at the two ends of the series connection are also each connected by a connecting bar, of appropriate shape, respectively to a positive output terminal and to a negative output terminal of the module. These two output terminals are labeled 31.

These output terminals 31 allow the connection of the module 1 to a device to be supplied with energy.

The facade element 50 is easily removable so as to allow access to the electronic card 4, particularly in the case of maintenance operations to be carried out on it. The positioning of the electronic card 4 outside the casing 2 makes access to it simpler, because it is no longer necessary to remove said casing, as is the case with known devices of the prior art.

In the variant embodiment shown in FIGS. 2, 3, 6 and 7, the facade element 50 containing the electronic card 4 is attached to the front face 210 of the casing 2. However, it is also possible to position this facade element 50, for example, against one of the side faces 213, 214.

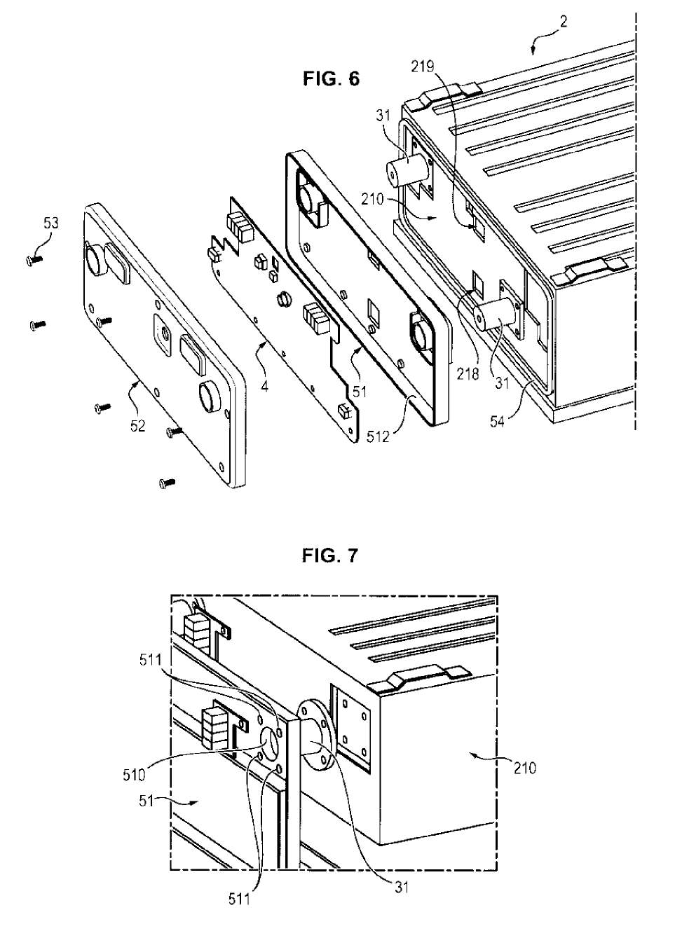

As it appears more clearly in FIG. 6, the facade element 50 comprises a rear portion 51 and a front portion 52, assembled so as to define an enclosure for receiving said electronic card 4.

The rear portion 51 has a generally parallelepiped shape, preferably equipped with peripheral rims 512. It is made of an electrically insulating material, such as plastic material. It plays the role of an interface between the electronic card 4 and the casing 2. It contributes in particular to the electrical insulation of the different voltage networks (high voltage, low voltage and ground). It also allows the electronic card 4 to be physically separated from the energy storage elements 3.

Advantageously, this rear portion 51 can integrate attachment means, such as clipping means, on one of the faces, preferably the front face 210, of the casing. Such means are not visible in the figures.

In addition, this rear portion 51 can integrate a connector (known by the term “backplane connector”) which makes it possible to ensure the connection between the electrical connectors coming from the inside of the module 1 and the electronic card 4.

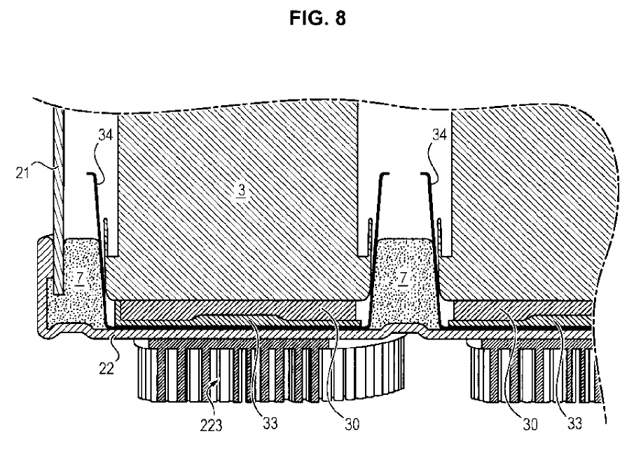

Advantageously, and as shown better in FIG. 7, the rear portion 51 can be used to hold the output terminals 31 or “power terminals” of the module 1. To this end, the portion 51 can be equipped with a central port 510 for the passage of the terminal 31 and with several ports 511 for passage of attachment screws. The output terminal 31 is thus retained between the portion 51 and the front face 210.

The front portion 52 is advantageously made of an electrically conductive material, such as metal, preferably aluminum or steel. Preferably, the same sheet metal is used as that used to make the hood 21 and the bottom 22.

The front portion 52 has a shape similar to the rear portion 51.

The front portion 52 is configured to be able to be assembled to the rear portion 51 by any appropriate attachment means, for example using screws 53.

The front portion 52 allows the electronic card 4 to be protected against shocks and electromagnetic currents. It also contributes to the liquid-tightness and gas-tightness of the module.

It will be noted that with the structure that has just been described, the module 1 thus has two main joining planes, namely a first between the hood 21 and the bottom 22 at its periphery, and the other between the facade element 50 and the face of the module against which this facade element is applied. In the first case, a seal can be provided in a single plane. In the second case, a seal 54 can be provided between the rear portion 51 and the front face 210, (see FIG. 6). In both cases, this thus simplifies the structure of the seal and its implementation. The module is thus better sealed, more robust and more reliable.

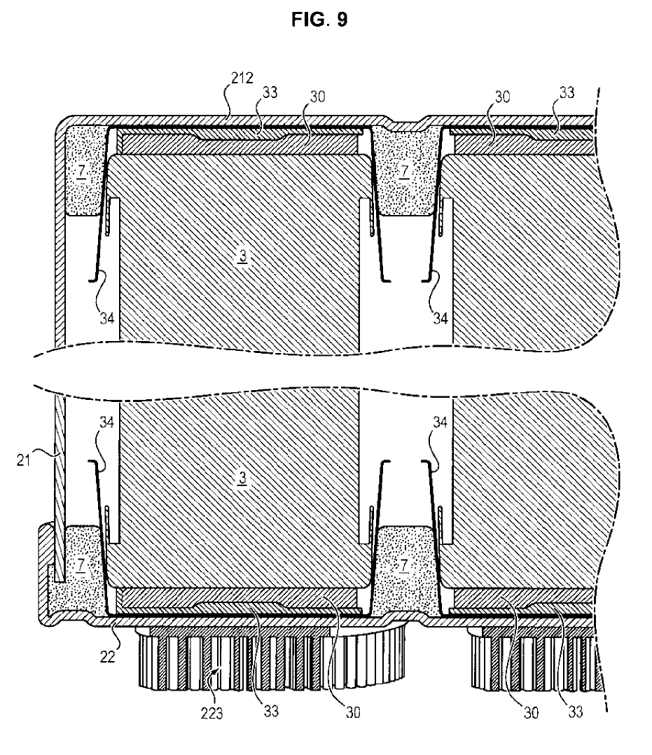

In conformity with the invention, the storage elements 3 are held in place inside the casing 2, and immobilized inside it, but a resin layer 7 which extends only over a portion of their height, as shown in FIGS. 8 and 9.

As can be seen in this figure, the resin 7 fills the existing spaces between two contiguous energy storage elements 3, as well as between these energy storage elements 3 and the hood 21 and/or the bottom 22.

Such a resin 7 allows in particular the blocking of the energy storage elements 3 along the longitudinal axis x and the lateral axis y (see FIG. 3) of the module. The blocking along the vertical axis z can for example be implemented using a foam element disposed at the vertical end of the energy storage elements 3, opposite to that being in contact with the bottom 22. This subject can also be referred to in document FR2916306.

In conformity with the invention, a first resin layer 7 is formed from the bottom 22 and over a portion of the height of the energy storage elements 3, preferably over a height comprised between 5% and 20%, more preferably between 5% and 12% of their height. Also formed is a second resin layer 7 from the upper face 212 of the hood 21 over only a portion of the height of the energy storage elements 3, for example over 5% to 20% of their height, preferably between 5% and 12% of their height.

Preferably, electrical energy storage elements 3 are held only by the aforementioned first and second resin 7 layers, i.e. there is no resin layer at the central portion of the element 3.

Preferably, the resin 7 is selected so as to have at least one of the following properties:
have good thermal conductivity, so as to transmit the heat generated by the elements 3 to the casing 2,
have the smallest possible density, so as not to encumber the weight of the module,
be sufficiently flexible to retain its integrity under mechanical forces (vibrations, shocks, etc.) and thermal constraints,
be non-flammable, opaque and not emit toxic smoke, according to applicable standards in force for this type of module,
have a level of electrical insulation sufficient to not degrade the insulation system of the module,
have good adhesion to aluminum if this material is used for the casing 2.

Preferably, this resin is polyurethane or silicone.

Such a resin allows the elements 3 to be blocked while still allowing wider geometric tolerances.

It also reinforces the connection between the bottom 22 and the hood 21, by thus limiting the number of screws necessary for the mechanical retention of the casing.

It also allows an improvement in the cooling properties of the module due to its mass effect.

It also participates in sealing between two elements of the casing. The bottom 22, equipped with its rims 221, also acts as a retention tray for the resin 7 prior to its polymerization.

Finally, this resin 7 has a reasonable cost.

According to the invention, the different elements constituting the storage module 1, as shown in FIGS. 2 to 9, are assembled as follows.

The different electrical energy storage elements 3 are assembled together two by two using connecting bars 30, so as to form a power block 32, i.e. an assembly of these elements 3.

Then, the electrical cabling of this power block 32 is accomplished so as to connect the electrical energy storage elements 3 situated at the ends of the series assembly to the electronic card 4.

The different electric insulators 33, 34 of the electrical energy storage elements 3 are then installed. This for example involves a layer of electrically insulating elastomer 33 and cups 34 made of polypropylene (PP) disposed at both ends of the elements 3 (see FIGS. 8 and 9).

The power block, labeled 32, is then disposed on the sheet-metal bottom 22, already equipped with the cooling fins 223 if it has them in the embodiment considered.

The hood 21 is then positioned on the bottom 22 and these two elements are assembled so as to surround the power block.

It is possible to insert a seal between the two.

The formation of the second resin layer 7 is then undertaken through an opening 218 (FIG. 2) provided in the casing 2, for example in the front face 210, in proximity to the bottom 22. The resin is allowed to polymerize for the necessary time, which can for example be 24 hours at a minimum and which depends on the type of resin used.

The turnover of the module 1 is then undertaken, so that the bottom 22 is oriented upward, then the second resin layer 7 is made by injection through an opening 219 (FIG. 2) provided in the casing 2, for example in the front face 210 in proximity to the upper face 212.

The openings 218, 219 can also serve for the passage of electrical cables connecting the inside of the module to the electronic card 4.

The end of the polymerization of the resin is then awaited, as for the preceding layer 7.

According to another variant embodiment not shown in the figures, the cups 34 are eliminated and the resin 7 then comes into contact with the connecting bars 30 and the layers of elastomer 33.

The rear portion 51 of the facade element 50 is then attached against one of the walls of the casing 2, for example the front face 210, as shown in the figures. This attachment is accomplished by preferably inserting a seal (gasket) between the two.

This can also block the openings 218, 219. Closing plugs can also be provided for blocking the openings 218, 219.

The electronic card 4 is then installed, and it is electrically connected to the power block 32. The output terminals 31 are also attached through the ports 510.

The front portion 52 of the facade element 50 is attached against the rear portion 51, having positioned a seal between the two.

It is then noted that the installation of this module is extremely simplified.

According to a variant embodiment, it will be noted that one or more ports or openings could be provided either in the bottom 22, or on the upper face 212 of the hood 21, to allow the introduction of the resin 7. In this case, it would be necessary to provide a closing plug for this (or these) port(s).

1. An electrical energy storage module containing electrical energy storage elements, wherein it comprises:
a parallelepiped casing made of sheet metal, inside of which are housed said electrical energy storage elements, said casing comprising a bottom assembled to a hood with five faces,
at least one electronic card disposed in a facade element, itself attached to one of the faces of said parallelepiped casing,
and in that said electrical energy storage elements are held in place and immobilized in the casing by a first resin layer which extends from said bottom over only a portion of the height of said electrical energy storage elements, and by a second resin layer which extends from one of the faces of the hood over only a portion of the height of said electrical energy storage elements.

2. The module according to claim 1, wherein it comprises two openings provided in the casing for the injection of resin into the casing, and preferably closing plugs for the two openings.

3. The module according to claim 2, wherein the two openings are formed on the front face of the hood, one situated in proximity to the bottom and the other situated in proximity to the upper face of the hood.

4. The module according to claim 2, wherein the two openings are formed, one in the bottom, the other in the upper face of the hood.

5. The module according to claim 1, wherein said casing is liquid-tight and dust-tight.

6. The module according to claim 1, wherein the casing is made of sheet metal of which the thickness is at most 5 mm.

7. The module according to claim 1, wherein it comprises a core, preferably central, forming a spacer, disposed between the bottom and the hood, perpendicular to them.

8. The module according to claim 1, wherein the resin extends over 5% to 20%, preferably 5% to 12%, of the height of the electrical energy storage elements.

9. The module according to claim 1, wherein the wall of its casing includes a crenelated surface.

10. The module according to claim 1, wherein the casing includes, over at least one of its faces, several heat dissipating elements, such as cooling fins, preferably welded to this face.

11. The module according to claim 1, wherein the facade element comprises a rear portion and a front portion equipped with assembly means allowing to assemble them to form an enclosure for receiving said electronic card, said rear portion being made of an electrically insulating material and being provided with attachment means on one of the faces of the casing and the front portion being made of an electrically conductive material, particularly a metal.

12. The module according to claim 1, wherein the facade element is pierced with ports allowing the passage of the output terminals, with positive and negative polarity, of said module.

13. A method for producing the electrical energy storage module according to claim 1, wherein it comprises the steps of:
assembling the electrical energy storage element in pairs using connecting bars,
implementing the electrical cabling and installing the insulators so as to form an isolated power block,
placing said power block inside the casing,
assembling the bottom and the hood of said casing,
injecting resin through a first opening of the casing to form said first resin layer,
waiting for the polymerization of the resin,
turning the module over,
injecting resin through a second opening of the casing to form a second resin layer,
attaching the facade element containing the electronic card to the casing.
